(19) United States
(12) Patent Application Publication
(10) Pub. No.: US 2007/0178942 A1
(43) Pub. Date: Aug. 2, 2007

(54) Method for abruptly stopping a linear vibration motor in portable communication device

(76) Inventors: Daniel J. Sadler, Gilbert, AZ (US); David B. Cranfill, Antioch, IL (US); Scott K. Isabelle, Waukegan, IL (US); Manuel Oliver, Scottsdale, AZ (US)

Correspondence Address: INGRASSIA FISHER & LORENZ, P.C., 7150 E. CAMELBACK, STE. 325, SCOTTSDALE, AZ, 85251, US

(21) Appl. No.: 11/343,177

(22) Filed: Jan. 30, 2006

(51) Int. Cl. H04B 1/38; G08B 5/22; H04B 3/36

(52) U.S. Cl. 455/567; 340/407.1; 340/7.6

(57) ABSTRACT

A method is provided for abruptly stopping a vibration motor providing tactile feedback (406) to the user of a portable communication device (100). The method comprises providing a drive waveform (401) including an attack signal (402), and a stop signal (411) out of phase with the attack signal (402), to one of the vibration motor (235) or the multi-function transducer (130) to quickly stop the vibration. The drive waveform may include an optional sustain signal (407) subsequent to the attack signal (402) and prior to the stop signal (411). A file stored in memory (212) is accessed to provide the drive waveform (401).

### FIELD OF THE INVENTION

The present invention generally relates to portable communication devices and more particularly to a method for abruptly stopping a vibration motor providing tactile feedback to the user of a portable communication device.

### BACKGROUND OF THE INVENTION

Given the rapid introduction of new types of portable electronic devices (e.g., Personal Digital Assistants, Text messaging pagers, MP3 players, cell phones), and the rapid development of novel functionality, an important objective in designing electronic devices is to provide intuitive user interfaces. Computer mouse-like keys and qwerty keyboards are some examples providing intuitive interfaces. However, these interfaces are directed more at providing input to the electronic device rather than providing content related feedback to a user. Touch screens along with graphical user interfaces (GUI) provide information to the user, but only if the user is looking at the screen.

Devices more recently are actively responding to user input by providing tactile cues or responses to the user. The vibrator in a cell phone or pager is a good example. Other examples include an input key that provides a clicking sound when moved; a key or touch screen that moves suddenly or vibrates in an opposed direction to the input; and a key that moves suddenly or vibrates perpendicular to the direction of input in response to a transducer attached to the device housing.

One area in which efforts have been made to improve the user's experience, is audio quality and tactile stimulation. Tactile stimulation is related to audio in the sense that low frequency audio can drive a resonant mass structure to produce a tactile stimulation.

Both audio and tactile stimulation can be provided by a single device known as a multi-function transducer (MFT). Certain types of MFT comprise a resiliently mounted speaker cone connected to a voice coil, and a resiliently mounted magnetic assembly that provides a magnetic field in which the voice coil operates. The resiliently mounted magnetic assembly and the speaker cone can be driven to oscillate by applying signals to the voice coil. The magnetic assembly owing to its mass and the compliance of its mounting will oscillate at a relatively low frequency within the range of frequencies that are easily perceptible by tactile sensation. Alternatively, a separate vibrating device for providing tactile stimulation, and a separate speaker for generating audio are used.

Multifunction transducers (MFTs) and AC linear vibration motors are becoming an often used alternative to DC motors in cellular phones. Such devices are resonant electromagnetic transducers which are typically driven by standard audio signals that contain frequency content at the transducer resonant frequency. One advantage to these types of motors is that they can provide a richer haptic experience, e.g., ramps and envelopes, when compared to their DC counterparts. Also, since they are included in the audio chain, these devices can provide haptic content which is easily incorporated within audio files and thus perfectly synchronized with audio. Finally, in the case of MFTs, a single transducer acts as both speaker and vibration motor, thereby reducing components and overall size of the cellular phone.

A key driver for utilizing MFTs and linear motors is a desire to enhance and improve the user experience. For this reason, much care must be taken in the design of “haptic waveforms”. It may be desired to provide multiple vibrations in succession, and the user must be able to differentiate between the multiple vibrations. However, this is a critical issue as known MFT devices and linear vibration motors require up to 200 milliseconds to decay from their peak acceleration value to 10% of the peak.

Accordingly, it is desirable to provide a method for abruptly stopping a vibration motor providing tactile feedback to the user of a portable communication device. Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

A method is provided for abruptly stopping a vibration motor providing tactile feedback to the user of a portable communication device. The method comprises providing a drive waveform including an attack signal, and a stop signal out of phase with the attack signal, to one of the vibration motor or the multi-function transducer to quickly stop the vibration. The drive waveform may include an optional sustain signal subsequent to the attack signal and prior to the stop signal. A file stored in memory is accessed to provide the drive waveform.

### BRIEF DESCRIPTION OF THE DRAWINGS

The present invention will hereinafter be described in conjunction with the following drawing figures, wherein like numerals denote like elements, and

FIG. 1 is an exploded view of a cellular telephone in accordance with a first exemplary embodiment;

FIG. 2 is a block diagram of the cellular telephone shown in FIG. 1;

FIG. 3 is a diametral cross-sectional side view of a multifunctional transducer used in the cellular telephone shown in FIGS. 1 and 2;

FIG. 4 is an exploded view showing internal components of the multifunction transducer shown in FIG. 3;

FIG. 5 is a drive waveform including both attack and sustain signals, and the resultant vibration;

FIG. 6 is a three-pulse drive waveform including both attack and sustain signals, and the resultant vibration;

FIG. 7 is the drive waveform including attack and sustain signals, along with the stop signal in accordance with an exemplary embodiment, and the resultant vibration; and

FIG. 8 is three-pulse drive waveform including attack and sustain signals, along with the stop signals in accordance with the exemplary embodiment, and the resultant vibration.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

A method is described for abruptly stopping a multi-function transducer (MFT) or other AC linear resonant vibration motor allowing for a user to more readily discern different haptic vibratory signals. One or more cycles of a sinusoid or multisine signal at the MFT resonant frequency (a “stop” signal) is applied 180 degrees out of phase with an attack signal used to initiate the MFT's vibration. The entire driving waveform may comprise three distinct sections: an “attack” signal, an optional “sustain” signal, and the “stop” signal. The transition from the sustain signal to the stop signal preferably occurs as the sustain signal passes zero volts. A discontinuity in the waveform derivative may occur (sensed as high frequency noise); however, this discontinuity may be substantially removed by the application of a low pass filter which acts to smooth the transition from the sustain signal to the stop signal.

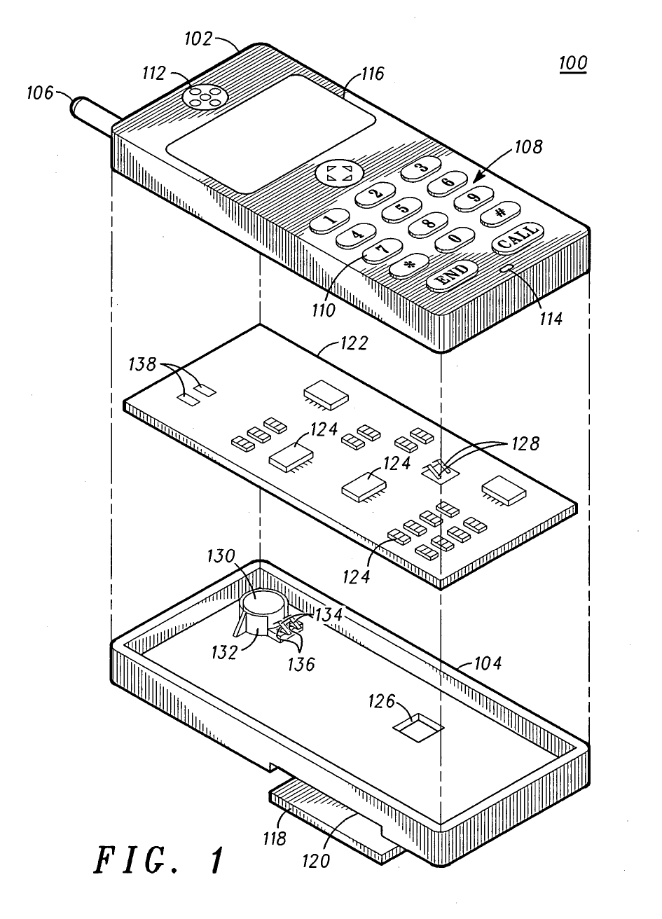

FIG. 1 is an exploded view of a cellular telephone 100 according to a first embodiment of the invention. The cellular telephone 100 comprises a front housing part 102, and a rear housing part 104. The front housing part 102 supports and antenna 106 and includes an array of openings 108 that accommodate keys of a keypad 110. A speaker grill 112 and a microphone grill 114 are also provided on the front housing part 102. A display opening 116 is also provided in the front housing part 102. A battery compartment cover 118 is provided for covering a battery compartment 120 in the rear housing part 104.

The front 102 and rear 104 housing parts enclose a circuit board 122. In FIG. 1 a back side of the circuit board 122 is visible. A plurality of electrical circuit components 124, that make up one or more electrical circuits of the cellular telephone 100 are mounted on the circuit board 122. Circuits of the cellular telephone 100 are more fully described below with reference to a functional block diagram shown in FIG. 2. The front side of the circuit board 122 (not shown), supports a display, and includes a plurality of pairs of open contacts that are selectively bridged by conductive pads attached to keys of the keypad 110. An opening 126 from inside the rear housing part 104 into the battery compartment 120, provides access for spring loaded contacts 128 that are mounted on the circuit board 122, and make contact with contacts on a battery (not shown) held in the compartment 120.

A multi-function transducer (MFT) 130 is mounted in a semi-cylindrical sleeve 132 that is integrally formed in the back housing part 104. A first pair of spring contacts 134 are coupled (e.g., by soldering) to a first pair of terminals 136 of the MFT 130. When the cellular telephone 100 is assembled the pair of spring contacts 134, make contact with a second pair of contact terminals 138 on the circuit board 122. The MFT 130 is capable of emitting sound and is also capable of vibrating at frequencies within the range of tactile perception, and at sufficient amplitude to be perceptible by tactile perception. The MFT 130 can be used to output multimedia content including audio and vibration signals that are derived from a variety of sources including MIDI files, and compressed audio format files, e.g., .WAV, .MP3 files.

FIG. 2 is a block diagram of the cellular telephone 100 shown in FIG. 1 according to the first embodiment of the invention. As shown in FIG. 2, the cellular telephone 100 comprises a transceiver 202, a processor 204, an analog to digital converter (A/D) 206, a input decoder 208, a memory 212, a display driver 214, a digital to analog converter (D/A) 218 coupled together through a digital signal bus 220.

The transceiver module 202 is coupled to the antenna 106. Carrier signals that are modulated by data, e.g., digitally encoded signals for driving the MFT or digitally encoded voice audio, pass between the antenna 106, and the transceiver 202.

A microphone 222 is coupled to the A/D 206. Audio, including spoken words, is input through the microphone 222 and converted to a stream of digital samples by the A/D 206.

The input device 110 is coupled to the input decoder 208. The input decoder 208 serves to identify depressed keys, for example, and provide information identifying each depressed key to the processor 204. The display driver 214 is coupled to a display 226.

The D/A 218 is coupled through an audio amplifier 232 to a speaker 234 and vibratory motor 235. The D/A 218 converts decoded digital audio to analog signals and drives the speaker 234 and vibratory motor 235. The audio amplifier 232 may comprise a plurality of amplifiers with each driving a separate speaker/vibratory motor combination. Alternatively, instead of driving the speaker 234 and vibratory motor 235, the audio amplifier 232 may be coupled to a multi-function transducer 130 as shown by the dotted line 228.

One or more programs for processing data structures that include digitally encoded signals for driving the MFT 130 are stored in the memory 212, and executed by the processor 204. Standard audio format files that include digitally encoded drive signals for the MFT 130 are optionally preprogrammed into the memory 212, or received through the transceiver 202.

The memory 212 is also used to store programs that control other aspects of the operation of the cellular telephone 100. The memory 212 is a form of computer readable medium.

The transceiver 202, the processor 204, the A/D 206, the input decoder 208, the memory 212, the display driver 214, the D/A 218, the audio amplifier 232, and the digital signal bus 220, are embodied in the electrical circuit components 124 and in interconnections of the circuit board 122 shown in FIG. 1.

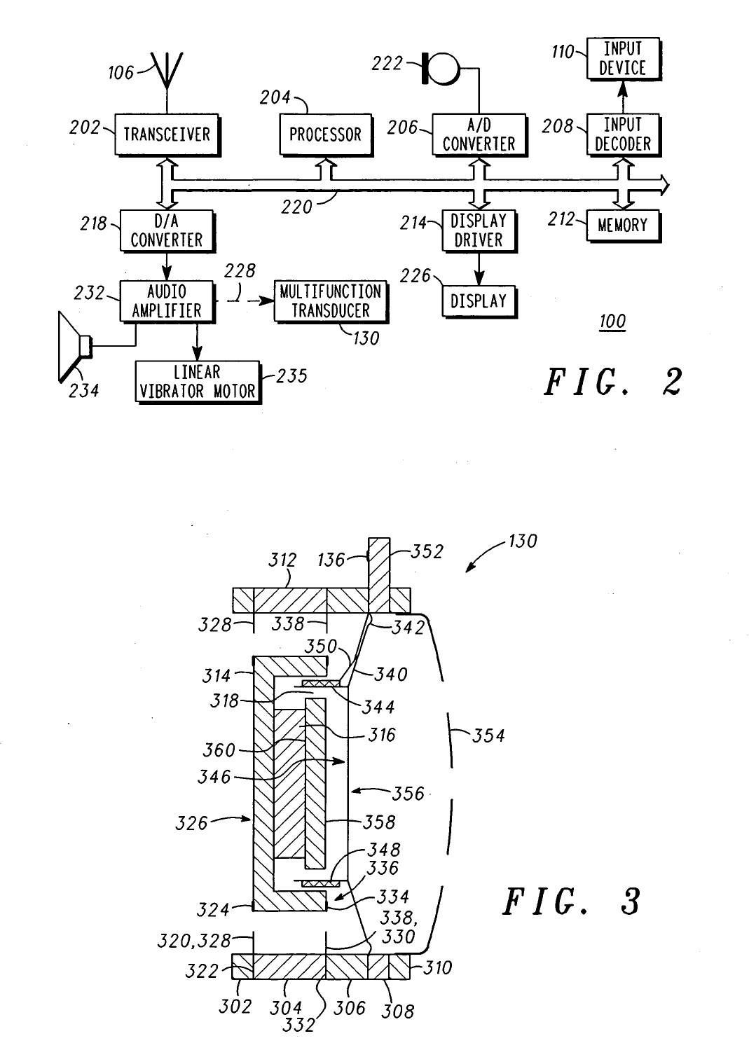

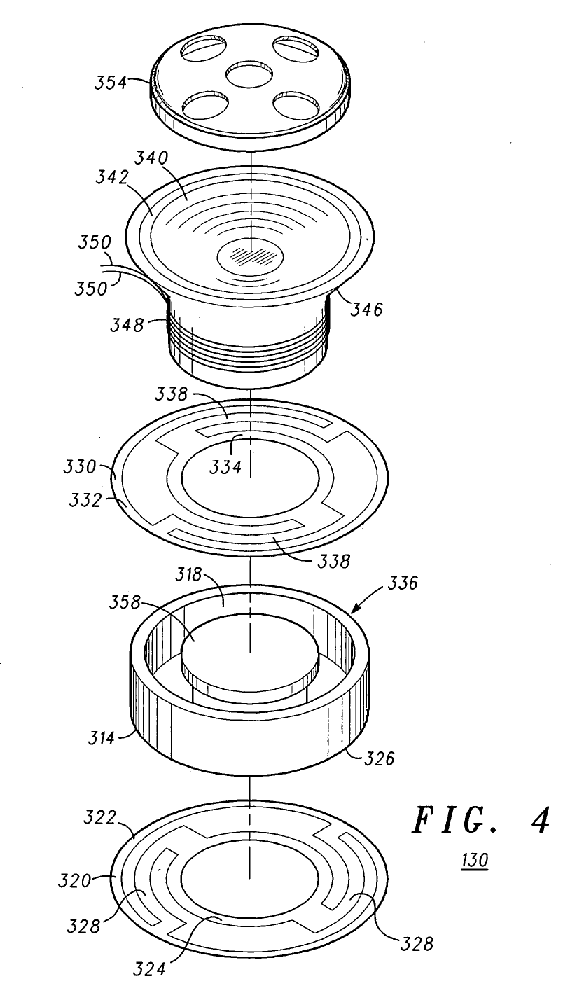

FIG. 3 is a diametral cross-sectional side view of the MFT 130 used in the cellular telephone 100 shown in FIGS. 1-2 according to the first embodiment of the invention and FIG. 4 is an exploded view showing internal components of the MFT 130. A plurality of rings including a first ring 302, a second ring, 304, a third ring 306, a fourth ring 308, and a fifth ring 310 are bonded together to form a housing 312 of the first MFT 130. The five rings 302, 304, 306, 308, 310 secure various other components of the first MFT 130 as will be described. A cup shaped ferromagnetic back plate 314 is located concentrically within the housing 312. A magnet 316 is bonded to and located concentrically within the cup shaped ferromagnetic back plate 314. A ferromagnetic pole piece 358 is bonded to the magnet 316. An outside diameter of the pole piece 358 is smaller than an inside diameter of the cup shaped back plate 314 so that there is an annular gap 318 between the cup shaped back plate 314, and pole piece 358. A magnetic field that comprises a strong radial component crosses the annular gap 318. The outside diameter of the pole piece 358 is larger than an outside diameter of the magnet 316 helping to direct the magnetic field radially in the annular gap 318.

A first spiral arm leaf spring 320 includes an outer ring 322 that is secured between the first 302, and second 304 rings of the housing 312, an inner ring 324 that is fixed (e.g., by spot welding) to a back surface 326 of the cup shaped back plate 314, and two spiral spring arms 328 that extend between the outer ring 322 and the inner ring 324. Similarly, a second spiral arm leaf spring 330 includes an outer ring 332 that is secured between the second 304, and third 306 rings of the housing 312, an inner ring 334 that is fixed (e.g., by spot welding) to a front surface 336 of the cup shaped back plate 314, and two spiral spring arms 338 that extend between the outer ring 332 and the inner ring 334. The magnet 316, pole piece 358, and back plate 314 make up a magnetic assembly 360. The magnetic assembly 360 is biased to a resting position by the first 320, and second 330 spiral arm leaf springs, which serve as a resilient support.

A speaker cone 340 is located concentrically in the housing 312. A speaker cone suspension 342 that is peripherally coupled to the speaker cone 340 is fixed between the third housing ring 306 and the fourth housing ring 308. The speaker cone suspension 342 is flexible to allow for axial movement of the speaker cone 340 in the housing 312. A cylindrical sleeve 344 is attached to a back surface 346 of the speaker cone 340. The cylindrical sleeve 344 is located in the annular gap 318. A voice coil solenoid 348 is wound on the cylindrical sleeve 344. Leads 350 of the voice coil solenoid 348 extend radially along the back surface 346 of the speaker cone 340, between the third 306 and fourth 308 housing rings and out to the terminals 136 of the first MFT 130 that are located on a radial extension 352 of the fourth housing ring 308. A perforated cover 354 is located in front of the speaker cone 340, and is secured (e.g., by press fitting) to the fifth housing ring 310. The speaker cone 340 comprises a front surface 356, which together with the back surface 346 serve to excite sound waves in a surrounding acoustic medium (e.g., air), when the speaker cone 340 is caused to oscillate.

In operation, broadband oscillating signals including audio signals, and vibration signals, that are applied to the leads 350 of the voice coil solenoid 348 produce commensurate currents in the voice coil solenoid 348. Owing to the fact that the voice coil solenoid 348 is immersed in the magnetic field crossing the annular gap 318, the currents flowing in the voice coil result in commensurate Lorentz forces between the voice coil solenoid 348, and the magnetic assembly 360. At any given instant the Lorentz force urges the speaker cone 340, and the magnetic assembly 360 in opposite directions. In so far as oscillating signals are applied to the voice coil solenoid, the Lorentz forces are oscillatory and therefore induce the voice coil solenoid 348, and the magnetic assembly 360 to oscillate. The voice coil solenoid 348 serves as a transducer motor, that is to say an element that converts electrical signals to mechanical forces and motion, in the MFT 130.

The magnetic assembly 360, supported by the spiral arm leaf springs 320, 330, constitutes a first mechanical resonator that exhibits a first resonance characterized by a center frequency and a Quality (Q) factor. The center frequency of the first mechanical resonator can be adjusted by altering the total mass of the magnetic assembly 360 and by altering the resiliency of the spiral arm leaf springs 320, 330 using the formula for the resonant frequency of a simple harmonic oscillator (SHO) given in equation 1, as a guide.

$$Fo = \frac{1}{2 π} \sqrt{\frac{k}{m}} \qquad EQUATION 1$$

where, k is the spring constant of the SHO; and

m is the mass of the SHO.

The center frequency of the first resonance can advantageously be between 120 and 180 Hz. Frequencies in the aforementioned range have been found to be useful in exciting vibrations that can be felt by users holding, or otherwise mechanically coupled to the cellular telephone 100. More particularly, the center frequency of the first resonance can advantageously be between about 140 and 160 Hz. Frequencies in the latter range have been found to be particularly efficacious.

The speaker cone 340 supported by the speaker cone suspension 342 forms a second resonator. The second resonator exhibits a second resonance that is characterized by a center frequency that is higher than the center frequency of the first resonance. However, the resonance of the second resonator is highly damped by excitation of the sound waves by the speaker cone 340, and thus the speaker cone 340, voice coil solenoid 348 system is able to operate effectively over a broad range of frequencies, to generate sound waves.

The attack signal 402 is typically a sinusoidal drive signal at the resonant frequency of the vibration device. An alternative would be to use a multi-sine signal when the resonant frequency is not known, or when using multiple devices having different resonant frequencies.

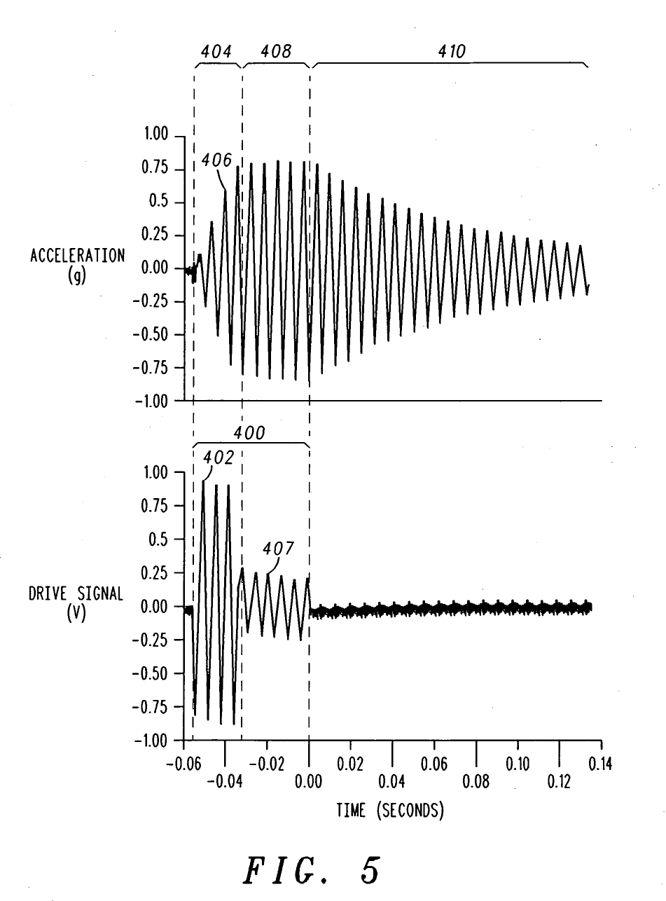

Referring to FIG. 5, a drive waveform 400 comprises an attack signal 402 and an optional sustain signal 407 that is in phase with the attack signal 402. The attack signal 402 is shown as a sinusoid for initiating vibration of the MFT 130. This application of the attack signal 402 produces the attack mode (vibration) 404. While 3.5 cycles of the attack signal 402 are shown for the attack mode 404, it should be understood that the duration of the attack signal 402 may vary. The application of the attack signal 402 to the MFT 130 will cause vibrations 406. A sustain signal 407 is applied during a “sustain” mode 408, such that the amplitude of the vibrations will remain constant or possibly continue to rise at a reduced rate. When the sustain signal 407 is removed at the end of the “sustain” mode 408, the vibrations will wind down slowly during a “wind down mode” 410. Known motors may take up to 200 milliseconds to decay from their peak acceleration value to 10% of the peak during this wind down mode 410.

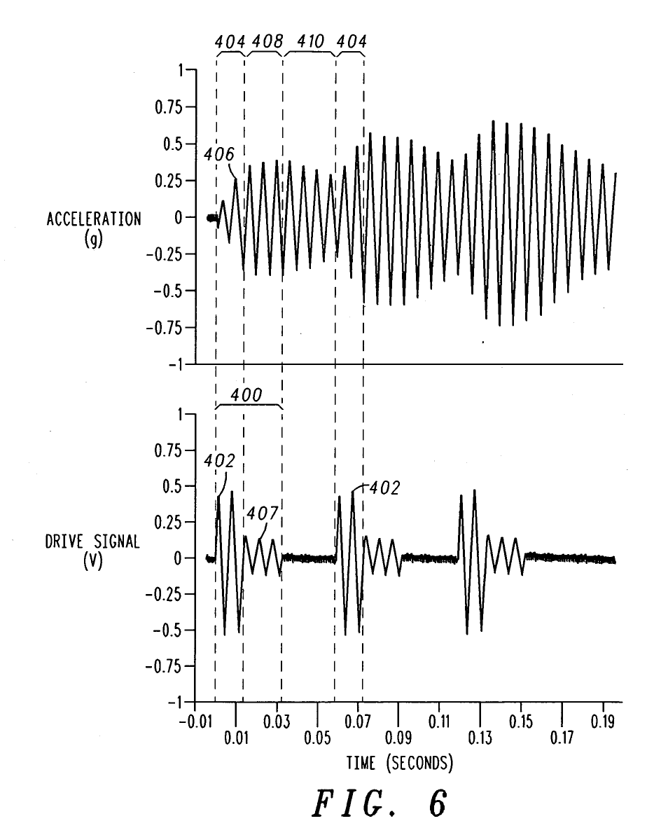

A series of three cycles of “attack” and “sustain” modes are illustrated in FIG. 6. It may be seen that the vibrations of the wind down period 410 have not decayed much before the next attack mode 404 is initiated. This slow decay of the vibrations during the wind down mode makes it difficult for a user to readily discern the difference between a series of haptic vibratory signals.

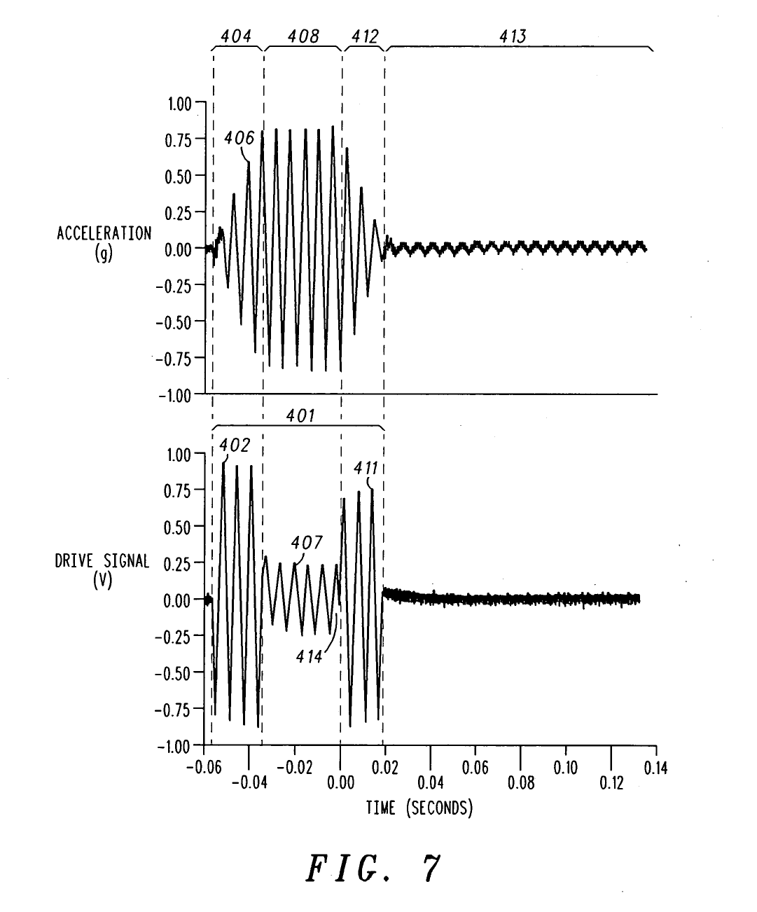

Referring to FIG. 7 and in accordance with an exemplary embodiment, the stop signal 411 (as part of the drive waveform 401) applied to the MFT 130 during a stop mode 412 is substantially similar to the attack signal 402 applied during the attack mode 404, except it is preferably 180 degrees, but may be near 180 degrees, out of phase. It may be seen that the vibrations 406 substantially abruptly winds down during the stop mode 412.

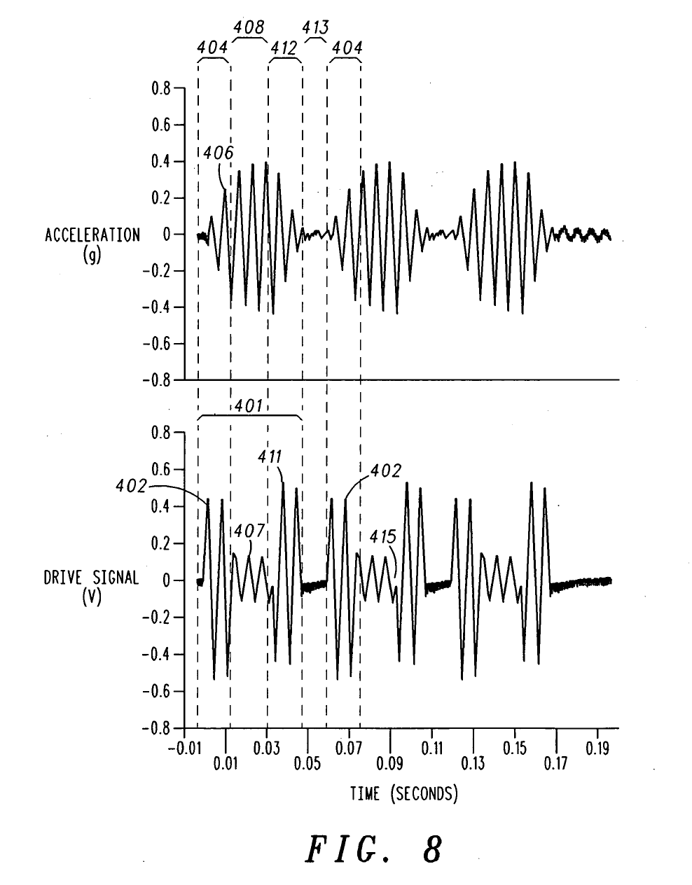

A series of three cycles of “attack”, “sustain”, and stop modes in accordance with the exemplary embodiment are illustrated in FIG. 8. It may be seen that the vibrations of the stop period 412 decay substantially before the next attack mode 404 is initiated, resulting in a period 413 of minimal or no vibration. This abrupt decay of the vibrations during the stop mode 412 makes it easier for a user to readily discern the difference between a series of haptic vibratory signals.

Application of the stop signal 411 that is out of phase with the attack signal 402 immediately following the sustain signal 407 to initiate the stop mode 412, may result in discontinuities in the waveform derivative 414 (i.e. a rapid change in signal direction) as seen in FIG. 7. Note that the stop signal 411 would be applied immediately after the attack signal 402 when the optional sustain signal 407 is not used. These undesirable discontinuities 414 occurring when the drive waveform 401 crosses the zero axis and quickly returns, are sensed as high frequency noise, such as a clicking sound, and may be substantially reduced or eliminated by application of a low pass filter function with a comer frequency significantly above, e.g., 2 times, the vibration resonant frequency. The drive waveform 401 shown in FIG. 8 has been filtered by an 8 h order Butterworth function with a comer frequency of 500 Hz, thus the signal at 415 does not cross the zero axis, but rather smoothly transitions from the sustain signal to the stop signal. Other methods such as manual editing of the file could also be employed to remove the discontinuity, resulting in the desired smooth transition.

It has been demonstrated that the method disclosed herein abruptly stops MFTs and AC linear vibration motors to produce crisp, sharp haptic effects which may be placed very close together in time without interfering with adjacent haptic signals.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims.

1. A method of providing tactile feedback to the user of a portable communication device comprising:
providing an attack signal to one of a vibration motor or a multi-function transducer; and
providing a stop signal out of phase with the attack signal to one of the vibration motor or the multi-function transducer.

2. The method of claim 1 further comprising providing to one of the vibration motor or the multi-function transducer, a sustain signal subsequent to the attack signal and prior to the stop signal.

3. The method of claim 1 wherein the providing a stop signal comprises providing a stop signal 180 degrees out of phase with the attack signal.

4. The method of claim 1 wherein the attack signal and the stop signal comprise a drive waveform generated by an audio file stored in memory.

5. The method of claim 2 wherein the attack signal, the sustain signal, and the stop signal comprise a drive waveform generated by an audio file stored in memory.

6. The method of claim 1 further comprising smoothing the transition from the attack signal to the stop signal.

7. The method of claim 2 further comprising smoothing the transition from the sustain signal to the stop signal.

8. A method of reducing vibrations of tactile feedback within a portable communication device comprising:
providing a profile for a drive waveform, the drive waveform comprising an attack signal and a stop signal;
driving an audio amplifier in response to the profile; and
driving a vibration device in response to an output from the audio amplifier.

9. The method of claim 8 wherein the drive waveform further comprises a sustain signal subsequent to the attack signal and prior to the stop signal.

10. The method of claim 8 wherein the stop signal is 180 degrees out of phase with the attack signal.

11. The method of claim 9 wherein the providing step comprises accessing an audio file containing the drive waveform stored in memory.

12. The method of claim 9 wherein the providing step comprises accessing an audio file containing the drive waveform stored in memory.

13. The method of claim 8 further comprising smoothing the transition from the attack signal to the stop signal.

14. The method of claim 9 further comprising smoothing the transition from the sustain signal to the stop signal.

15. A method of providing tactile feedback to the user of a portable communication device including a processor, a digital-to-analog device, an audio amplifier, a memory, and a vibrating device, the method comprising:
generating instructions from the processor to provide a drive waveform, including an attack signal followed by a stop signal, to the digital-to-analog device;
driving the audio amplifier by the digital-to-analog device in response to the drive waveform;
vibrating the vibrating device in response to an analog signal from the audio amplifier.

16. The method of claim 15 wherein the drive waveform further includes a sustain signal subsequent to the attack signal and prior to the stop signal.

17. The method of claim 15 wherein the stop signal is 180 degrees out of phase with the attack signal.

18. The method of claim 15 wherein the generating instructions step comprises accessing an audio file stored in memory.

19. The method of claim 16 wherein the generating instructions step comprises accessing an audio file stored in memory.

20. The method of claim 15 further comprising smoothing the transition from the attack signal to the stop signal.

21. The method of claim 16 further comprising smoothing the transition from the sustain signal to the stop signal.
